(19) United States
(12) Patent Application Publication
(10) Pub. No.: US 2008/0278448 A1
(43) Pub. Date: Nov. 13, 2008

(54) Control Device

(76) Inventors: Jonas Nilsagard, Savedalen (SE); Olle Takman, Molnlycke (SE)

Correspondence Address: BUCHANAN, INGERSOLL & ROONEY PC, POST OFFICE BOX 1404, ALEXANDRIA, VA, 22313-1404, US

(21) Appl. No.: 11/887,146

(22) PCT Filed: Mar. 17, 2006
(86) PCT No.: PCT/SE2006/000336

§ 371 Date: Mar. 18, 2008

(30) Foreign Application Priority Data
Mar. 30, 2005 (SE) 0500698-6

(51) Int. Cl. G06F 3/033

(52) U.S. Cl. 345/161

(57) ABSTRACT

A control device (1) for providing four position parameters of an object (7) attached to a displacement device (6) using a rotatable structure (2) with three determinable position parameters: x and y tilt and rotational angle around a z axis; the forth parameter being a position in the z direction of the displacement device (6).

### FIELD OF THE INVENTION

The present invention relates to a control device with at least four degrees of freedom, and in particular a control device reading two tilt angle deviations in x and y, one rotation angle around a z axis, and a linear deviation in the z-axis.

### BACKGROUND OF THE INVENTION

Many different types of control devices have been constructed for various purposes. The most common control device is the so called mouse giving positioning variables in two dimensions for use in controlling operation of applications on a computer. Other interface control devices include the so called joystick which gives positioning variables also in two dimensions from the stick; however, by using extra buttons in conjunction with the stick it is possible to enhance the number of “positioning variables”, but it should be understood that this device physically only measures positioning variables in two dimensions. A trackball also delivers data for two dimensions; a game pad often uses a small joystick like handle for measuring positioning variables and may extend the range of the functionality of the controller to more control data by utilizing extra buttons; a steering wheel (for computer gaming) delivers data in one dimension.

In many solutions found, the control device only gives reference measurements and not absolute measurements, meaning that for an application relying on absolute coordinates of the control device to function properly complex computing is needed to continuously keep track of the location of the control device. Still such devices either need to be calibrated regularly or they will continuously build up an error that quickly may become critical depending on application.

Often for applications within industrial and/or professional areas, two dimensions do not suffice but measurement of more physical positioning variables would be advantageous. For this purpose several solutions may be found in the literature, for instance in WO 8805942, wherein a joystick apparatus having six degrees of freedom is shown, in U.S. Pat. No. 5,854,622, wherein a joystick for measuring movement in six degrees of freedom is shown, or in U.S. Pat. No. 5,565,891, wherein a hand manipulated six degree of freedom controller is shown. However, in many of these cases the solutions are complex to use and expensive to manufacture, and/or they may be difficult to implement into certain application areas depending on their geometrical dimensions and design.

The above mentioned applications all aim towards a handheld controlling device for controlling some external process such as a computer game or control of machinery, vehicles, or other equipment. In some areas of interest it is desirable to have a device that can measure the position and movement of an object inserted into or attached to the device. For instance within simulation of surgical procedures or the like. However, devices for this purpose are often bulky, complex, and expensive meaning there are a need for a cost efficient and reliable solution for these applications.

### SUMMARY OF THE INVENTION

It is the object of the present invention to provide a control device measuring position variables in four dimensions, and with the extra option of providing extra control data by using separate control buttons in conjunction with the positioning measurements.

A first aspect of the present invention, a control device for providing a position of an object with at least four position parameters is provided, comprising:
a rotatable structure;
at least one sensor for measuring a position of the rotatable structure;
a displacement unit providing a linear displacement and a signal proportional to the linear displacement;
   wherein the at least one sensor is in sensing contact with the rotatable structure for determination of a position of the rotatable structure in a first, second, and third position parameter, the displacement unit is arranged in mechanical connection to the rotatable structure and provides a measurement in a fourth position parameter, the control device is further arranged to provide a signal indicative of the four position parameters.

The sensor may be a non-contacting sensor. The non-contacting sensor may be an optical sensor or a magnetic sensor measuring magnetic properties.

The optical sensor may be arranged to detect an optical pattern on the rotatable structure. The optical pattern is a pre-configured pattern enhancing a resolution of the determination of the first, second and third position parameters.

The sensor for measuring magnetic properties may be arranged to measure a magnetic pattern on the rotatable structure.

The sensor may be an impedance measuring sensor using slip rings.

Part of the displacement unit may be arranged in a hole arranged at least partly through the rotatable structure.

The hole through the rotatable structure may be arranged substantially through a center portion of the rotatable structure.

A first object may be arranged in mechanical connection to the displacement unit.

The first object arranged in mechanical connection to the displacement unit may be a handle operable by a user.

The handle may comprise at least one interface unit providing function signals.

The first object may be a receiving device for receiving a second object and comprising a clamping device holding the second object.

The first object arranged in mechanical connection to the displacement unit may be a medical simulation device arranged to receive a medical instrument or a simulated medical instrument for use inside a mammal body.

The medical instrument or simulated medical instrument may be at least one of endoscope, laparoscope, rectoscope, catheter, stent, and laryngoscope.

The control device may further comprise at least one spring mechanism attached to the rotatable structure allowing linear translation of the rotatable structure in a plane perpendicular to the displacement device.

The at least one sensor and/or displacement unit measure absolute positions of the first object attached to the displacement unit.

The four parameters include angle deviations in two dimensions, a rotational angle around an axis perpendicular to the two dimensions, and a linear displacement parameter in the direction of the axis perpendicular to the two dimensions.

The control device may further comprise force feedback applied to at least one of the rotatable structure and the displacement device.

These and other aspects of the invention will be apparent from and elucidated with reference to the embodiments described hereinafter.

### BRIEF DESCRIPTION OF THE DRAWINGS

In the following the invention will be described in a non-limiting way and in more detail with reference to exemplary embodiments illustrated in the enclosed drawings, in which:

FIG. 1a illustrates a side view of a control device according to the present invention;

FIG. 1b illustrates a top view of a control device according to the present invention;

FIG. 2 schematically illustrates a processing device according to the present invention;

FIG. 3 illustrates a detailed view of the control device from FIG. 1a;

FIG. 4 illustrates a linear displacement device according to the present invention.

FIG. 5 illustrates a control device with a handle according to the present invention.

### DETAILED DESCRIPTION OF THE INVENTION

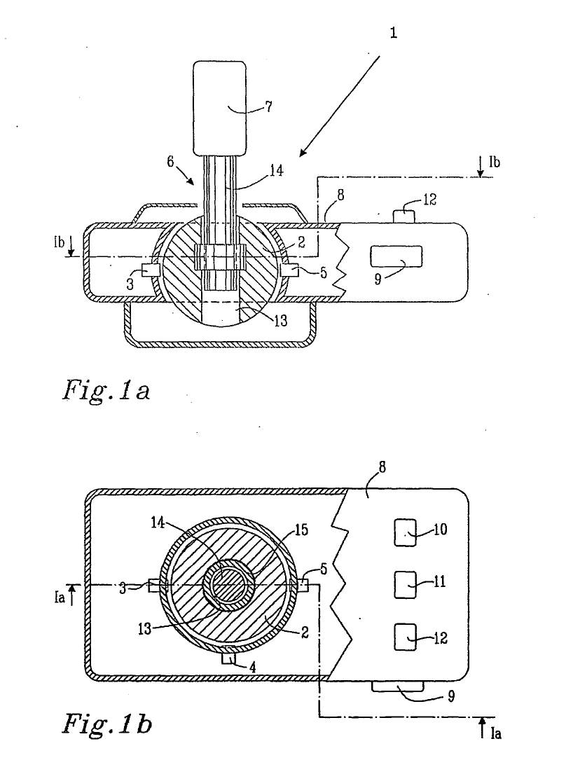

The present invention is a control device 1 illustrated in FIGS. 1a and 1b comprising a rotatable structure 2 (such as a ball like structure), at least one sensor 3, 4, and 5, a displacement device 6, whereto an object 7 may be attached, and a casing 8 surrounding some of the components. The control device 1 further comprises electrical connectors 9, and optional buttons 10, 11, and 12. FIG. 1a illustrates a schematically side view of the device 1 along the line 1a in FIG. 1b and FIG. 1b is a schematically top view along the line 1b in FIG. 1a.

The rotatable structure 2 may be attached to the casing 8 or other holding structures with springs (not shown) or may rotate freely in a cradle with enough tight mechanical design so as to keep the rotatable structure in place. Wheels or other bearing mechanisms (not shown) may hold the rotatable structure 2 in correct and stable position for the sensors 3, 4, and 5 to take readings of the position of the rotatable structure 2. In an embodiment the rotatable structure 2 is a ball like structure, however since it need not rotate full turn in all directions, it may deviate from a spherical structure, for instance it may be truncated at the top and/or bottom end where the displacement device 6 exits.

The displacement device 6 may be attached to a hole 13 in the rotatable structure 2 allowing for movement through the ball 2 of the displacement device 6 or the object 7 attached to the displacement device 6.

The displacement device 6 may be a linear displacement measuring unit with one part held fixed and another part movable in relation to the fixed part, for instance an outer part 15 fixed in relation to the rotatable structure 2 and an inner part 14 movable in one direction with respect to the fixed outer part 15. Some sensing means are incorporated into the linear displacement device 6 measuring the relative position of the inner part 14 with respect to the outer part 15. It should be appreciated by the person skilled in the art that the function may be switch between the outer part 15 and the inner part 14 with respect to both location of sensing means and which part is fixed relative the rotatable structure 2. With the term linear regarding the linear displacement device 6 means the mechanical function; however an electrical signal emanating due to the displacement need not be linear but of any calibrated function as understood by the person skilled in the art. Depending on the application of the control device 1, different solutions for the linear displacement may be used. In some cases the displacement device 6 can extend through the rotatable structure 2 and even extend out below the rotatable structure 2 or even the casing 8, in such situations the displacement device 6 can comprise a long shaft or similar movable structure in relation to the fixed portion of the device 6; however if the displacement device 6 is not allowed to pass through and/or below the rotatable structure, a telescopic action may be provided for the part of the displacement device 6 that is movable in relation to the fixed part. In such a case with the displacement device 6 not allowed to pass through the rotatable structure, a spring may be provided in order to urge the movable part back to a starting position, wherein the spring may be located inside the rotatable structure 2 at the bottom of the hole 13; the hole not extending all the way through the rotatable structure 2.

At least one sensor 3, 4, and 5 is attached to the casing 8 and measures one or several position dependent variables. These are used for determining the absolute position of the rotatable structure in three angle positions. The sensors 3, 4, and 5 may be of an optical sensing type reading a pattern on the surface of the rotatable structure 2. The optical sensor may be a camera obtaining an image of the pattern and with suitable image processing the position of the rotatable structure 2 in three angle variables may be obtained. By utilizing a pre-configured pattern known to the image processing system enhanced resolution of the variables may be obtained. The three angles may be tilt angles in x and y directions and a rotational angle around an axis pointing in a z-direction, perpendicular to a plane defined by the x and y directions. The displacement device 6 as well as the hole 13 may be located so as to have their longitudinal direction along this z-direction.

Sensors may be located with appropriate angles around the periphery of rotatable structure 2 as understood by the person skilled in the art, for instance when using three sensor 3, 4, and 5 the may be located at 120° relative position around the rotatable structure 2. They may also be located on different planes, for instance two sensors 3 and 4 on one plane perpendicular to an axis along the linear displacement device 6 when in relaxed (or neutral) position, and one sensor 5 may be located in a different position away from above mentioned plane (e.g. directly under the rotatable structure 2, a bottom end of the rotatable structure 2, or in a position between the bottom end and the plane defined above).

Buttons 10, 11, and 12 may be used for functions as for instance on/off, reset, or for adding functionality when in combination with the movement of the rotatable structure 2 and/or displacement device 6. The control device 1 may include buttons or other interface units on a handle or similar attached to the displacement device 6 for convenient handling of extra functions, allowing for one hand maneuvering of equipment controlled by the control device 1. An example of such extra functionality and interface solutions may be found further below in discussions of different types of applications examples.

All movable parts of the control device, including functional buttons or other user interface units may be provided with spring mechanisms in order to urge them back to a starting position.

In a preferred embodiment two optical sensors 3 and 4, located at 90° or 120° between each other, are used for determining the angular position of the rotatable structure 2; however, the invention is not limited to this number of sensors, more or less number of sensors may be used. The optical sensors may for instance be of a CMOS (complementary metal oxide semiconductor) or CCD (charge coupled device) image acquiring type for obtaining images of the rotatable structure 2 surface pattern. Image processing is used to track features of the pattern and determine the relative movement from image to image. By pre-configuring a known pattern, with unique features in the pattern, onto the surface it is possible to have an absolute measurement of the rotatable structure position. With already one optical sensor and image tracking processing without any pre configured pattern, it is possible to have a relative position determining system. With one sensor 3 and a pre configured pattern absolute positioning of the rotatable structure is possible using image tracking. In another embodiment one or several magnetic sensors 3, 4, and 5 measure on a magnetic pattern and a similar pattern tracking as for the optical system may be used in locating and determining a relative or absolute position of the rotatable structure 2.

The pattern should be of a suitable size and type depending on sensing element used, for instance the size should match the resolution and image area when using an optical sensor.

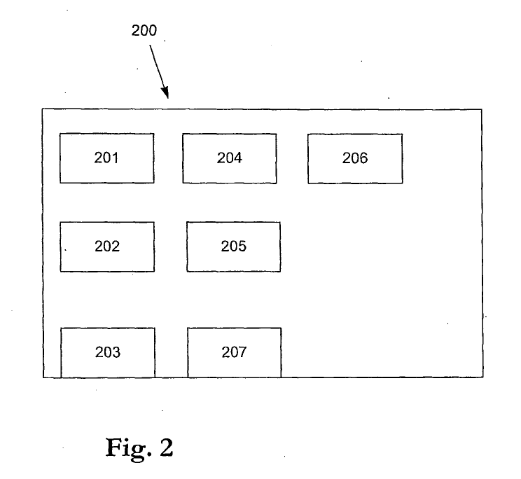

Signals from the sensors 3, 4, and 5, and the displacement device 6 are all transferred to a processing device 200, illustrated in FIG. 2, via a connector 207, for image processing and signal conditioning in order to provide a signal or signals indicative of the position of the rotatable structure 2 and displacement device 6 to some external device connected to the processing device using a connector 203. The processing device may include a processor 201, memory unit (or units) 202, image processing unit 204, and other units 205 and 206 depending on application for the control device. The processing unit may have a communication interface for communicating with external devices, or optional units attached to the control device 1. Such optional units may include, but is not limited to, force feedback, clamping devices, or similar interaction devices for interacting with a user of the control device. Interfaces for both communicating with external devices or internal sensor inputs may be provided through any suitable connector or connectors as understood by the person skilled in the art, including, but not limited to, USB (universal serial bus), Firewire, RS232, RS485, Ethernet, Centronics parallel port, GPIB (general purpose interface bus), different wireless interfaces (e.g. Bluetooth and WLAN), and so on. The listed interfaces are all according to existing standard interfaces but it should be understood that it may also involve future standard solutions or even proprietary interfaces.

Non-contacting sensor means may advantageously be utilized since the rotatable structure 2 is encapsulated within the casing 8 of the control device 1; however, these types of sensors may be used even if there is no encapsulation. Therefore, there is a small amount of disturbances that can influence the reading, such as dirt, light, or stray magnetic fields. In one embodiment the casing 8 is made of an electrically conducting material with magnetic shielding properties in order to reduce the risk of influencing a magnetic sensor measuring the position of the rotatable structure 2.

However, the invention is not limited to non-contacting measurements of the rotatable structure 2 position, contacting sensors can also be used, including, but not limited to, slip rings, impedance measurements, voltage dividers, digital encoders, and capacitive measurements.

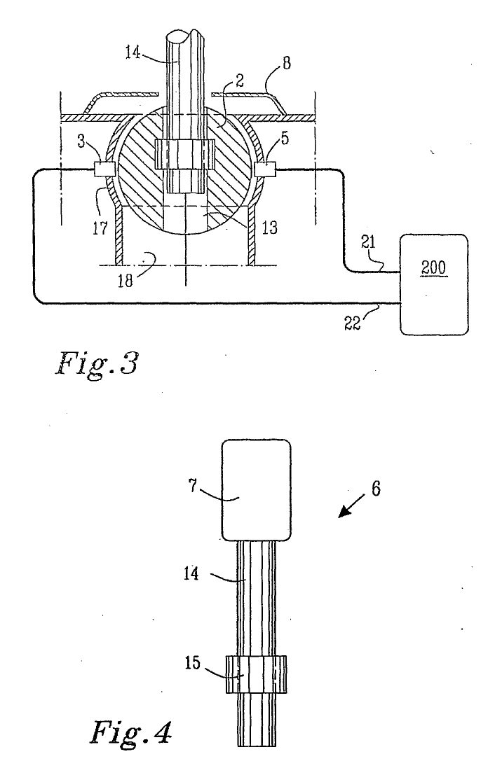

FIG. 3 shows a detailed view of the control device 1 according to the present invention. In this case the displacement device 6 is allowed to pass through the rotatable structure 2 and further below into the lower parts of the casing or even further if applicable depending on application and mounting. A holding structure 17 for holding the rotatable structure is provided with a hole 18 larger than the movable part 14 of the displacement device 6. This is necessary in order to allow for the tilting movement in x and y directions. For instance, the casing 8 may define the allowable x and y tilting direction range or the holding structure 17 may be used for the same purpose. Sensors 3 and 5 for determining the position of the rotatable structure 2 is located in or on the holding structure 17. Signals from sensors 3 and 5 are propagated in signal lines 21 and 22 to the processing device 200 for processing. Signals from the displacement device 6 may also be propagated to the processing device 200 using appropriate signal line or lines (not shown). The number of sensors and signal lines are not limited to the shown quantity but they may be more or less depending on application and type and number of sensors used. In the same manner signals from function buttons 10, 11, and 12 or any other interface functionality are propagated in suitable signal lines to the processing device 200.

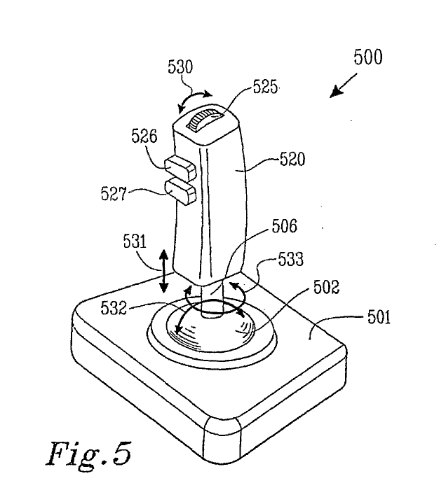

FIG. 4 shows the linear displacement device 6 used in the present invention; However, other types of displacement devices may be used as understood by the person skilled in the art. In FIG. 4 an outer part 15 and an inner part 14 are in movable relation to each other and electrical connectors for measuring the position of the two elements relative each other can be located either on the outer part 15 or the inner part 14. An object 7 can be positioned, attached, or in mechanical connection with the either the inner part 14 or the outer part 15. In FIG. 4 it is attached to the inner part 14. This object 7 can be for instance a handle possibly containing further control interface units (buttons, switches, or relays), a receiving device for receiving another object to be positioned (e.g. a surgical instrument to be simulated or emulated), or a alignment device used in aligning distant objects. More on this may be found in below listed examples of usage of the present invention.

The control device with four position parameters may be used as an angle detecting device due to the high accuracy of the angle measurements available when the pre-configured pattern is utilized on the surface of the rotatable structure 2. A system for this type of application, need to have a pattern that is tuned to the sensor chosen, i.e. the size of the pattern parts need to be small enough so as to fit a suitable part of the pattern in the field of view of the sensor at each time. For instance, for an optical sensor reading images several pattern parts should be visible. However, the pattern may not be too small, because then there is a risk that the image sensor will loose details due to the limited resolution of the image sensor element and thus misread.

A multi dimensional control device may find application within computer gaming applications, vehicle control (steering cars, trucks, aero planes, helicopters, and buses), machine control, such as for heavy construction machinery (excavators, loading machinery, mining, and so on), and cranes, and for simulation devices. Simulation devices are found in many different areas, such as for training pilots, machine operators, medical doctors, and so on. FIG. 5 is a perspective view of a control device 500 for use in gaming and/or professional applications. The control device 500 comprises a base plate 501, a rotatable structure 502, a displacement device 506, a handle 520, a scroll wheel 525, and function buttons 526 and 527. The base plate 501 may be arranged for stand alone purposes, wherein the control device 500 is used for instance in a gaming application and need to be standing on a table or carried, or arranged for mounting purposes, for instance in a professional application (e.g. as control device in machinery equipment), for fix or semi-fix mounting of the control device in a suitable location within or adjacent to equipment to be controlled. The control device 501 further comprises a handle 520 providing a grip and optional buttons 526 and 527 and/or scroll wheel 525 in order to provide additional functions and movement control signals of equipment to be controlled. The scroll wheel 525 function may also be designed as a toggle switch providing signals indicative of two directions (e.g. forward or backward) of movement. The handle 520 is mechanically connected to the displacement device 506 and when the operator presses up or down it will move accordingly and the displacement device 506 will generate signals indicative of this displacement. At the same time the displacement device 506 is in mechanical connection with the rotatable structure 502 enabling displacement in x and y tilt directions and rotation around the z-axis as described earlier. Sensors measuring the rotatable structure 2 movements will generate signals indicative of this displacement. Within the control device 501 a processing unit is located in order to process the signal from the different sensors and function interfaces (buttons, switches, and relays) and provide signals to equipment to be controlled, e.g. a computer controlling a computer game or a processing unit controlling machinery. Such signals may be provided through any suitable connector (not shown) as understood by the person skilled in the art, including, but not limited to, USB (universal serial bus), Firewire, RS232, RS485, Ethernet, Centronics parallel port, GPIB (general purpose interface bus), different wireless interfaces (e.g. Bluetooth and WLAN), and so on. Arrows 531, 532, and 533 indicate some of the possible displacement directions of the control device 500, arrow 530 indicate a displacement direction of the scroll wheel 525. Arrow 532 is indicative of one tilting direction of the control device 500; however other tilting directions are possible, all around the 360° periphery of the handle 520 of the ball 502.

The control device 1 according to the present invention may be used as an interface unit to a computer for use in a computer game or similar or as an interface unit in a simulation device (e.g. a flight simulator). In one embodiment, a plurality of control devices 1 are connected to a single interface unit (not shown), for instance two control devices 1 according to the present invention, wherein one control device is used to control one process and the other control device is used for controlling another process. For instance in a gaming application (computer game) one device may be used for controlling the movement of a character in view and the other control device is used for controlling a device held by the character (e.g. a weapon or similar). Thus a user may simultaneously operate several functions or actions at the same time. This dual control device feature may be used for controlling other equipment as well as understood by the person skilled in the art.

In usage, training, and/or programming of robots, a control device 1 according to the present invention may be used. A person may control the robot using the control device 1 during use of the robot or in programming of the robot for doing automated tasks. A robot may in this application be a device used in an automatic manufacturing process, such as in an assembly line in a factory or similar operation.

In training of professionals within medicine, such as doctors, surgeons, or veterinaries for invasive and/non-invasive surgery inside of a mammal body, simulation and/or emulation devices are used. These allow for surgical or diagnostic devices, for instance laparoscopy instruments or other instruments for keyhole surgery or diagnosis, e.g. laparoscope, catheter, stent, laryngoscope, or endoscope, to be entered into the simulation or emulation device (hereinafter referred to as a simulation device) in order to give the person using the simulation device a feeling of a real environment. Other applications within the medical field may be of interest, e.g. rectoscope, gynecological examination, and dental work. On a computer screen the person under training will see an instrument under simulation and movements of this according to sensor signals measuring the movements of the surgical device entered into the simulation device. In such an application the control device 1 according to the present invention will find applicability. The surgical device is entered into an opening of the control device 1 casing 8 and a receiving mechanism 7 will receive the surgical device and hold it during the simulation. The receiving mechanism may be incorporated with the displacement device 6 and thus is it allowed to move in the “z-direction” and the tilting directions of the x, and y directions and rotation about the z-axis. The control device will measure the displacement of the surgical device in the z direction, rotation in the z-direction, and the x and y tilt directions. The processing device will measure the position of the surgical device and forward data indicative of this position to a processing system of the simulation device, which in will use these data to update the computer screen with images of an instrument in relation to the simulated device.

More than one simulated surgical instrument can be applied simultaneously to the control device 1 by for instance attaching several receiving mechanisms 7 in parallel or in serial connection with each other or to the displacement device 6.

In this type of application it is advantageous to use mechanical interactive feedback as well as the visual feedback provided by the computer screen. Such mechanical interactive feedback involves force feedback providing the user with mechanical forces that might be encountered in a real situation. Clamping or frictional devices may provide realistic frictional forces for certain situations in training, such as simulation of instruments penetrating blood vessel walls, encountering turns or bends of blood vessels, encountering bones, or interfacing with other bodily parts. For instance the holding device receiving the instrument upon entry may be arranged to hold the instrument with a certain force and allow displacement of the instrument, or force may be applied to the linear displacement device 6 and/or the rotatable structure 2.

In yet another application of the present invention a tilt or aligning measuring instrument may be provided. An aiming device may be located on the displacement device and an operator holds a handle attached to the displacement device and aims the aiming device towards an object to be aligned with the bit measuring instrument. When the object is properly aligned In the aiming device the corresponding tilt and z parameters can be read out using either a display attached to the tilt measuring instrument or fed to a separate reading device (e.g. a computer). This may be used for alignment purposes or for measuring a location of a distant object.

In still another application of the present invention a digitizer may be provided. The digitizer is used for determining a physical structure of an object by determining a plurality of outer limiting points on the object. This is done by holding a probe (attached to the displacement device 6) to the object and reading the position parameters associated with this location using the four position parameters from the control device according to the present invention now acting as a reading device. In order to increase the displacement flexibility (i.e. the number of degrees of freedom) of the reading device one or several linkage arms may be needed.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be implemented by means of both hardware and software, and that several “means” may be represented by the same item of hardware.

The above mentioned and described embodiments are only given as examples and should not be limiting to the present invention. Other solutions, uses, objectives, and functions within the scope of the invention as claimed in the below described patent claims should be apparent for the person skilled in the art.

1. A control device for providing at least four position parameters, comprising:
a rotatable structure;
at least one sensor for measuring a position of said rotatable structure;
a displacement unit providing a linear displacement and a signal proportional to said linear displacement;
wherein said at least one sensor is in sensing contact with said rotatable structure for determination of a position of said rotatable structure in a first, second, and third position parameter, said displacement unit is arranged in mechanical connection to said rotatable structure and provides a measurement in a fourth position parameter, said control device is further arranged to provide a signal indicative of said four position parameters.

2. The control device according to claim 1, wherein said sensor is a non-contacting sensor.

3. The control device according to claim 2, wherein said non-contacting sensor is an optical sensor.

4. The control device according to claim 3, wherein said optical sensor is arranged to detect an optical pattern on said rotatable structure.

5. The control device according to claim 4, wherein said optical pattern is a pre-configured pattern enhancing a resolution of the determination of said first, second, and third position parameters.

6. The control device according to claim 2, wherein said sensor is a sensor for measuring magnetic properties.

7. The control device according to claim 6, wherein said sensor for measuring magnetic properties is arranged to measure a magnetic pattern on said rotatable structure.

8. The control device according to claim 1, wherein said sensor is an impedance measuring sensor using slip rings.

9. The control device according to claim 1, wherein part of said displacement unit is arranged in a hole arranged at least partly through said rotatable structure.

10. The control device according to claim 9, wherein said hole through said rotatable structure is arranged substantially through a center portion of said rotatable structure.

11. The control device according to claim 1, wherein a first object is arranged in mechanical connection to said displacement unit.

12. The control device according to claim 11, wherein said first object arranged in mechanical connection to said displacement unit is a handle operable by a user.

13. The control device according to claim 12, wherein said handle comprise at least one interface unit providing function signals.

14. The control device according to claim 11, wherein said first object is a receiving device for receiving a second object and comprising a clamping device holding said second object.

15. The control device according to claim 11, wherein said first object arranged in mechanical connection to said displacement unit is a medical simulation device arranged to receive a medical instrument or a simulated medical instrument for use inside a mammal body.

16. The control device according to claim 15, wherein said medical instrument or simulated medical instrument is at least one of endoscope, laparoscope, rectoscope, catheter, stent, and laryngoscope.

17. The control device according to claim 1, further comprising at least one spring mechanism attached to said rotatable structure allowing linear translation of said rotatable structure in a plane perpendicular to said displacement device (6).

18. The control device according to claim 11, wherein the at least one sensor and displacement unit measure absolute positions of said first object attached to said displacement unit.

19. The control device according to claim 1, wherein said four parameters include angle deviations in two dimensions, a rotational angle around an axis perpendicular to said two dimensions, and a linear displacement parameter in the direction of said axis perpendicular to said two dimensions.

20. The control device according to claim 1, further comprising force feedback applied to at least one of said rotatable structure and said displacement device (6).
